(19) United States
(12) Patent Application Publication
(10) Pub. No.: US 2024/0416795 A1
(43) Pub. Date: Dec. 19, 2024

(54) METHOD FOR CONNECTING A HIGH-VOLTAGE BATTERY TO A HIGH-VOLTAGE SYSTEM IN A DRIVETRAIN OF AN ELECTRIC OR HYBRID VEHICLE

(71) Applicant: AMPERE S.A.S., Boulogne Billancourt (FR)

(72) Inventors: Maria AGAPIOS, Guyancourt (FR); Alessandro MONTI, Guyancourt Cedex (FR); Martin PEREZ-CHUECOS, Guyancourt (FR)

(73) Assignee: AMPERE S.A.S., Boulogne Billancourt (FR)

(21) Appl. No.: 18/703,983

(22) PCT Filed: Oct. 28, 2022
(86) PCT No.: PCT/EP2022/080175

§ 371 Date: Apr. 23, 2024

(30) Foreign Application Priority Data
Oct. 28, 2021 (FR) FR2111505

(51) Int. Cl. B60L 58/12; B60L 50/60; B60W 20/00; H01M 10/42; H01M 10/48

(52) U.S. Cl. CPC B60L 58/12; B60L 50/60; B60W 20/00; H01M 10/425; H01M 10/48; B60L 2240/547; H01M 2220/20

(57) ABSTRACT

A method is for connecting a high-voltage battery to a high-voltage network using at least one relay in a powertrain of an electric or hybrid vehicle. The method includes precharging the high-voltage network according to a preset precharging setpoint; achieving connection between the high-voltage battery and the high-voltage network by closing the relay; measuring the difference between the voltage of the high-voltage battery and the voltage of the high-voltage network when the high-voltage battery and the high-voltage network are connected and the current of the high-voltage battery is zero; and establishing a corrected precharging setpoint depending on the measured difference between the high-voltage battery and the high-voltage network for a subsequent connection.

The present invention relates, generally, to electric or hybrid vehicles, such as motor vehicles for example, equipped with relays allowing a battery to be connected to the electrical network of a powertrain.

More precisely, the invention relates to a method for connecting a high-voltage battery to a high-voltage network using a relay in a powertrain of an electric or hybrid vehicle, and to an associated powertrain.

An electromechanical relay is an electrical component that is actuated by an electromagnet and that plays the role of a switch to distribute power when a command is issued by a control. It thus allows an electrical power circuit to be opened and closed to reflect a logic state.

An electric arc may be created through ionization of the insulating medium, which is generally air. Once ionized, the gas creates a conductive channel that extracts the rest of the charge present on the starting surface. Provided that the potential difference remains sufficient, the arc then continues even if the surfaces are separated from each other, but a field several orders of magnitude under the critical electric field is required to ionize air.

A high current generally flows through an electric arc. For this reason an electric arc causes strong electromagnetic interference. The surfaces of the conductive parts connected by an arc deteriorate greatly, in particular because of the temperature of the arc. This may easily be seen by observing wear of the contact terminals of electrical relays.

Connecting, via relays, a battery to an electrical network that is at a non-zero voltage runs a risk of an electric arc forming in the relay. The greater the voltage difference, the higher the current of the electric arc formed.

In present-day electric or hybrid motor vehicles, as the voltage difference between the electrical network and the battery may range from 200V to 800V. commonly used relays are only able to withstand being switched about ten times on account of the degradation produced following electric-arc formation.

To reduce, in the relay, the inrush current associated with the electric arc generated when the battery and the electrical network are connected, it is conventional to precharge the electrical network to bring it to the same voltage level as the battery. If the voltage levels of the battery and of the high-voltage network are identical, when the relay is closed, the inrush current is zero and therefore no electric arc is formed. This improves the durability of the relays.

A number of solutions for precharging a high-voltage network of a powertrain are known.

One solution is to add a specific circuit for precharging the high-voltage network from the high-voltage battery. This circuit incorporates a resistor and an additional precharging relay. The resistance of the resistor is very high in order to greatly limit the inrush current generated when the precharging circuit is closed. Once the high-voltage network has been precharged, or in other words when it is at the same voltage level as the high-voltage battery, the main relay may be closed without an electric arc forming.

Another solution consists in precharging the high-voltage network by means of a low-voltage battery via a direct current/direct current boost converter (DC/DC boost converter).

Conventionally, voltage sensors are associated with the high-voltage battery and with the high-voltage network. An electronic control unit controlling the high-voltage battery sends the voltage level of the latter to a master electronic control unit, said voltage level being recorded by the voltage sensor associated with the battery. Depending on the received information, the master control unit sends a precharge-voltage setpoint of the high-voltage network to an electronic control unit controlling the DC/DC boost converter.

The DC/DC boost converter uses the energy of the low-voltage battery to raise the voltage of the high-voltage network, and in particular of its capacitors, to the voltage setpoint received by the master electronic control unit. When the high-voltage network has been precharged, the main relay may be closed without an electric arc forming.

However, various parameters affect the accuracy of the voltage sensors of the high-voltage battery and of the high-voltage network, such as production tolerances, aging, the temperature to which they are exposed, the voltage level of the high-voltage battery and electrical and electronic design.

Therefore, even should the voltage sensor of the electronic control unit of the battery and the voltage sensor of the electronic control unit of the DC-DC boost converter estimate the same voltage value, there may nonetheless be a large difference in actual voltage between the high-voltage battery and the high-voltage network. Despite the precharging, an electric arc may form when the relay is closed and damage the latter.

The aim of the invention is therefore to remedy these draw backs, and to provide a simple method allowing a high-voltage battery to be connected to a high-voltage network while preventing an electric arc from forming, without it being necessary to provide a specific additional circuit.

A method for connecting a high-voltage battery to a high-voltage network using at least one relay in a powertrain of an electric or hybrid vehicle is therefore provided, this method comprising:

precharging the high-voltage network according to a preset precharging setpoint:

achieving connection between the high-voltage battery and the high-voltage network by closing the relay:

measuring the difference between the voltage of the high-voltage battery and the voltage of the high-voltage network when the high-voltage battery and the high-voltage network are connected and the current of the high-voltage battery is zero; and

establishing a corrected precharging setpoint depending on the measured difference between the high-voltage battery and the high-voltage network for a subsequent connection.

According to one embodiment, one or more consumers may be connected to the high-voltage network and consume power from the high-voltage battery when the high-voltage battery and the high-voltage network are connected, the voltage difference between the high-voltage battery and the high-voltage network being measured before the consumers consume power from the high-voltage battery.

According to another embodiment, one or more consumers may be connected to the high-voltage network and consume power from the high-voltage battery when the high-voltage battery and the high-voltage network are connected, the voltage difference between the high-voltage battery and the high-voltage network being measured after the consumers have finished consuming power from the high-voltage battery, before the high-voltage battery is disconnected from the high-voltage network.

Preferably, the voltages of the high-voltage battery and of the high-voltage network are measured using voltage sensors, the method further comprising a step of carrying out mapping of temperatures of the voltage sensors, the corrected precharging setpoint being established depending on the temperatures recorded during mapping.

According to another embodiment, the voltages of the high-voltage battery and of the high-voltage network are measured using voltage sensors. The method further comprises a step of carrying out mapping of voltages measured by one of said voltage sensors, while the current of the high-voltage battery is zero, the corrected precharging setpoint being established depending on the measured voltages recorded during mapping.

Advantageously, the step of establishing the corrected precharging setpoint may be carried out in each cycle of connection between the high-voltage battery and the high-voltage network.

The invention also relates to a powertrain for an electric or hybrid motor vehicle, the powertrain comprising a high-voltage battery, a high-voltage network, at least one relay for connecting the high-voltage battery to the high-voltage network, and a control device configured to:

command precharging of the high-voltage network according to a preset precharging setpoint:

command connection between the high-voltage battery and the high-voltage network by closing the relay:

command measurement of the difference between the voltage of the high-voltage battery and the voltage of the high-voltage network when the high-voltage battery and the high-voltage network are connected and the current of the high-voltage battery is zero; and

establish a corrected precharging setpoint depending on the measured difference between the high-voltage battery and the high-voltage network for a subsequent connection.

According to one embodiment, one or more consumers of power from the high-voltage battery may be connected to the high-voltage network, the control device being configured to measure the voltage difference between the high-voltage battery and the high-voltage network, when the high-voltage battery and the high-voltage network are connected, before the consumers consume power from the high-voltage battery.

According to another embodiment, one or more consumers of power from the high-voltage battery may be connected to the high-voltage network, the control device being configured to measure the voltage difference between the high-voltage battery and the high-voltage network, when the high-voltage battery and the high-voltage network are connected, after the consumers have finished consuming power from the high-voltage battery, before the high-voltage battery is disconnected from the high-voltage network.

Advantageously, the powertrain may comprise a sensor of the voltage of the high-voltage battery, a sensor of the voltage of the high-voltage network, and a system for carrying out mapping of temperatures of said voltage sensors, the control device being configured to carry out mapping of temperatures of said voltage sensors and to establish the corrected precharging setpoint depending on the temperatures recorded during mapping.

According to another embodiment, the powertrain comprises a sensor of the voltage of the high-voltage battery, a sensor of the voltage of the high-voltage network, and a system for carrying out mapping of voltages measured by one of said voltage sensors, the control device being configured to carry out mapping of voltages measured by said voltage sensor and to establish the corrected precharging setpoint depending on the measured voltages recorded during mapping.

The invention also relates to a motor vehicle comprising a powertrain such as described above.

Other aims, advantages and features will become more clearly apparent from the following description, which is given purely by way of illustration with reference to the appended drawings, in which:

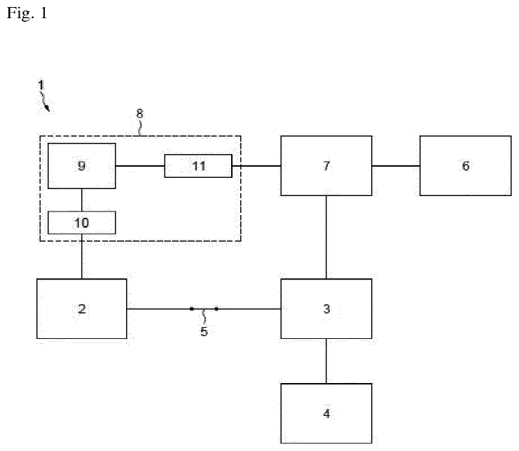

FIG. 1 is a schematic representation of the electrical circuit of a powertrain of an electric or hybrid vehicle, according to one embodiment of the invention.

Below, the expression “at least one” as used in the present description is equivalent to the expression “one or more”.

FIG. 1 schematically illustrates an electrical circuit 1 of a powertrain of an electric or hybrid vehicle.

In the illustrated example, the vehicle is a motor vehicle.

According to another embodiment, provision may be made for the vehicle not to be a motor vehicle, but for example to be a train or boat.

The illustrated powertrain is equipped with a high-voltage battery 2 and a high-voltage network 3. High-voltage consumers 4 are connected to the high-voltage network 3 so that they may consume power from the high-voltage battery 2 when the high-voltage battery 2 and the high-voltage network 3 are connected.

The consumers 4 are, for example, an electric motor or hybrid engine ensuring locomotion of the motor vehicle or an electric motor ensuring air conditioning of the passenger compartment.

At least one electromechanical relay 5 allows, by opening or closing, the high-voltage network 3 and the high-voltage battery 2 to be disconnected or connected, respectively.

Preferably, the powertrain also comprises a low-voltage battery 6 and an electronic direct current/direct current boost converter 7, referred to below as the DC/DC boost converter 7.

In the illustrated example, all the elements of the high-voltage network, including the consumers 4 and the DC/DC boost converter 7, are connected in parallel.

The powertrain further comprises a control device 8 configured to:

command precharging of the high-voltage network 3 depending on a preset precharging setpoint:

command connection between the high-voltage battery 2 and the high-voltage network 3 by closing the relay 5:

command measurement of the difference between the voltage of the high-voltage battery 2 and the voltage of the high-voltage network 3 when the high-voltage battery 2 and the high-voltage network 3 are connected and the current of the high-voltage battery 2 is zero; and

establish a corrected precharging setpoint depending on the measured difference between the voltages of the high-voltage battery 2 and of the high-voltage network 3 for a subsequent connection between the high-voltage battery 2 and the high-voltage network 3.

In the illustrated example, the control device 8 comprises a master first electronic control unit 9, a second electronic control unit 10 associated with the high-voltage battery 2 and a third electronic control unit 11 associated with the DC/DC boost converter 7.

The second electronic control unit 10 is configured to manage the high-voltage battery 2 and to measure its voltage. The voltage of the high-voltage battery 2 is measured using at least one sensor (not shown) of the voltage of the high-voltage battery.

The third electronic control unit 11 is configured to manage the power conversion by the DC/DC boost converter 7 and to measure the voltage of the high-voltage network 3. The voltage of the high-voltage network 3 is measured using a sensor (not shown) of the voltage of the high-voltage network.

Lastly, the master first electronic control unit 9 is configured to centralize the information of the measurements of the voltages of the high-voltage battery 2 and of the high-voltage network 3, which information is received from the first and second electronic control units 10 and 11, to sequence the precharging of the high-voltage network 3, to learn and correct the voltage measurements, and to control opening and closing of the relay 5.

The first, second and third electronic control units 9, 10 and 11 communicate with one another via, for example, a CAN bus (CAN standing for Controller Area Network) or an Ethernet network.

According to one alternative, provision may be made for the master first electronic control unit 9, the second electronic control unit 10 and the third electronic control unit 11 to form a number of electronic control units different from three, or even one and the same electronic control unit.

When the high-voltage network 3 is disconnected from the high-voltage battery 2 and the consumers 4 of the high-voltage network 3 require power, a request to connect the high-voltage network 3 is received by the master first electronic control unit 9 and a connection cycle begins.

The high-voltage network 3 is precharged depending on a preset precharging setpoint, in order to raise the voltage of the high-voltage network 3 to the same voltage level as the high-voltage battery 2. Precharging allows the inrush current to be reduced in the relay 5 when the high-voltage network 3 and the high-voltage battery 2 are connected.

In the illustrated example, precharging is achieved using the DC/DC boost converter 7 and the low-voltage battery 6. The DC/DC boost converter 7 uses the energy of the low-voltage battery 6 to increase the voltage of the high-voltage network 3 to the preset precharging setpoint. The established precharging setpoint may be computed based on a previous connection cycle.

It is then possible to carry out the precharging without it being necessary to add a specific circuit comprising a resistor and an additional precharging relay.

The high-voltage battery 2 and the high-voltage network 3 may then be connected by closing the relay 5, which is controlled by the control device 8, and more particularly, in the illustrated example, by the master first electronic control unit 9.

As long as consumers 4 connected to the high-voltage network 3 require power, the relay 5 remains closed.

When none of the consumers 4 needs to consume power, or for reasons regarding the safety of the high-voltage network 3, the control device 8, and more particularly, in the illustrated example, the master first electronic control unit 9, orders the relay 5 open to disconnect the high-voltage network 3 from the high-voltage battery 2.

When every power generator or consumer connected to the high-voltage network 3 has stopped, the current of the high-voltage battery 2 becomes zero. Since all the elements connected to the high-voltage network 3 are connected in parallel, the voltage of the high-voltage battery 2 and the voltage of the high-voltage network 3 are physically the same.

When the high-voltage battery 2 and the high-voltage network 3 are connected and the current of the high-voltage battery 2 is zero, the difference between the voltage of the high-voltage battery 2 and the voltage of the high-voltage network 3 is measured.

The second electronic control unit 10 sends the measurement of the voltage of the high-voltage battery recorded by the voltage sensor of the high-voltage battery to the master first electronic control unit 9. The third electronic control unit 11 sends the measurement of the voltage of the high-voltage network 3 recorded by the voltage sensor of the high-voltage network to the master first electronic control unit 9.

The voltage difference is measured by the control device 8, and in particular, in the illustrated example, by the master first electronic control unit 9. If, at this time, there is a difference between the voltage measured by the sensor of the voltage of the high-voltage battery 2 and the sensor of the voltage of the high-voltage network 3, this difference is stored by the control device 8, and in particular in this example by the master first electronic control unit 9, with a view to correcting the precharging voltage setpoint sent to the control device 8, and in this example to the third electronic control unit 11 of the DC/DC boost converter 7, for a subsequent connection between the high-voltage network 3 and the high-voltage battery 2.

A corrected precharging setpoint is then established by the control device 8, and advantageously by the master first electronic control unit 9, depending on the measured difference between the high-voltage battery 2 and the high-voltage network 3, for a subsequent connection.

Learning the voltage difference and correcting the precharging setpoint make it possible to correct measurement inaccuracies of the sensors of the voltage of the high-voltage battery and of the high-voltage network, these inaccuracies being due to production tolerances, aging, the voltage level of the high-voltage battery 2 and electrical and electronic design.

Once the difference has been learnt, the control device 8, and in particular in this example the master first electronic control unit 9, commands the relay 5 to open in order to disconnect the high-voltage network 3 from the high-voltage battery 2.

In the following connection cycle, the precharging setpoint sent by the master first electronic control unit 9 to the third electronic control unit 11 associated with the DC/DC boost converter 7 corresponds to the precharging setpoint corrected depending on the voltage difference measured in the previous connection cycle.

Correcting inaccuracies of the voltage sensors makes it possible to eliminate the inrush current generated when the relay 5 closes, and hence no electric arc forms.

Preferably, the corrected precharging voltage setpoint computed by the master first electronic control unit 9 is the sum of the voltage measurement recorded by the voltage sensor of the high-voltage battery 2 and of the difference between the voltage measurements of the sensors of the voltage of the high-voltage battery and of the high-voltage network at zero current, which difference was learnt in a previous cycle of connection between the high-voltage battery 2 and the high-voltage network 3.

Preferably, the voltage difference between the high-voltage battery 2 and the high-voltage network 3 is measured, while the current of the high-voltage battery 2 is zero, after the consumers 4 have finished consuming power from the high-voltage battery, before the high-voltage battery is disconnected from the high-voltage network.

This makes it possible not to delay delivering power from the high-voltage battery 2 to the consumers 4 of the high-voltage network 3 once a request for connection between the high-voltage battery 2 and the high-voltage network 3 has been made.

In another embodiment, provision may also be made for the voltage difference between the high-voltage battery 2 and the high-voltage network 3 to be measured, while the current of the high-voltage battery 2 is zero, before the consumers 4 consume power from the high-voltage battery 2.

The powertrain may further comprise a temperature-mapping system intended to carry out mapping of temperatures of the voltage sensors of the high-voltage battery 2 and of the high-voltage network 3.

In this respect, the illustrated control device 8 is configured to carry out mapping of temperatures of the voltage sensors and to establish the corrected precharging setpoint depending on the temperatures thus recorded.

It is then possible to correct inaccuracies of the voltage sensors depending on the temperature to which they are exposed.

The powertrain may further comprise a voltage-mapping system intended to carry out mapping of voltages measured by one of said voltage sensors of the high-voltage battery 2 and of the high-voltage network 3, while the current of the high-voltage battery 2 is zero.

This voltage sensor is considered to be a reference voltage sensor, here for example the voltage sensor of the high-voltage battery.

In this case, the illustrated control device 8 is configured to carry out mapping of voltages measured by the voltage sensor of the high-voltage battery and to establish the corrected precharging setpoint depending on the voltages thus recorded.

It is then possible to correct inaccuracies of the voltage sensors depending on the voltage measured by the voltage sensor of the high-voltage battery. This measured voltage may vary, for example as a result of relaxation of cells of the high-voltage battery 2.

It should be noted that it is possible to combine use of mapping of temperature and of measured voltage to establish the corrected precharging setpoint.

A corrected precharging setpoint may be established in each cycle of connection of the high-voltage battery 2 to the high-voltage network 3.

1-12. (canceled)

13. A method for connecting a high-voltage battery to a high-voltage network using at least one relay in a powertrain of an electric or hybrid vehicle, comprising:
precharging the high-voltage network according to a preset precharging setpoint;
achieving connection between the high-voltage battery and the high-voltage network by closing the relay;
measuring a difference between a voltage of the high-voltage battery and a voltage of the high-voltage network when the high-voltage battery and the high-voltage network are connected and a current of the high-voltage battery is zero; and
establishing a corrected precharging setpoint depending on the measured difference between the high-voltage battery and the high-voltage network for a subsequent connection.

14. The connecting method as claimed in claim 13, wherein one or more consumers connected to the high-voltage network consume power from the high-voltage battery when the high-voltage battery and the high-voltage network are connected, the voltage difference between the high-voltage battery and the high-voltage network being measured after the consumers have finished consuming the power from the high-voltage battery, before the high-voltage battery is disconnected from the high-voltage network.

15. The connecting method as claimed in claim 13, wherein one or more consumers connected to the high-voltage network consume power from the high-voltage battery when the high-voltage battery and the high-voltage network are connected, the voltage difference between the high-voltage battery and the high-voltage network being measured before the consumers consume the power from the high-voltage battery.

16. The connecting method as claimed in claim 13, wherein the voltages of the high-voltage battery and of the high-voltage network are respectively measured using voltage sensors, the method further comprising mapping temperatures of the voltage sensors, the corrected precharging setpoint being established depending on the temperatures recorded during the mapping.

17. The connecting method as claimed in claim 13, wherein the voltages of the high-voltage battery and of the high-voltage network are respectively measured using voltage sensors, the method further comprising mapping voltages measured by one of said voltage sensors, while the current of the high-voltage battery is zero, the corrected precharging setpoint being established depending on the measured voltages recorded during the mapping.

18. The connecting method as claimed in claim 13, wherein the establishing the corrected precharging setpoint is carried out in each cycle of connection between the high-voltage battery and the high-voltage network.

19. A powertrain for an electric or hybrid motor vehicle, the powertrain comprising:
a high-voltage battery;
a high-voltage network;
at least one relay configured to connect the high-voltage battery to the high-voltage network; and
a control device configured to:
command precharging of the high-voltage network according to a preset precharging setpoint,
command connection between the high-voltage battery and the high-voltage network by closing the relay,
command measurement of a difference between the voltage of the high-voltage battery and the voltage of the high-voltage network when the high-voltage battery and the high-voltage network are connected and a current of the high-voltage battery is zero; and
establish a corrected precharging setpoint depending on the measured difference between the high-voltage battery and the high-voltage network for a subsequent connection.

20. The powertrain as claimed in claim 19, further comprising one or more consumers of power from the high-voltage battery that are connected to the high-voltage network, the control device being configured to measure the voltage difference between the high-voltage battery and the high-voltage network, when the high-voltage battery and the high-voltage network are connected, after the consumers have finished consuming the power from the high-voltage battery, before the high-voltage battery is disconnected from the high-voltage network.

21. The powertrain as claimed in claim 19, further comprising one or more consumers of power from the high-voltage battery that are connected to the high-voltage network, the control device being configured to measure the voltage difference between the high-voltage battery and the high-voltage network, when the high-voltage battery and the high-voltage network are connected, before the consumers consume the power from the high-voltage battery.

22. The powertrain as claimed in claim 19, further comprising a sensor of the voltage of the high-voltage battery, a sensor of the voltage of the high-voltage network, and a system for carrying out mapping of temperatures of said voltage sensors, the control device being configured to carry out the mapping of temperatures of said voltage sensors and to establish the corrected precharging setpoint depending on the temperatures recorded during the mapping.

23. The powertrain as claimed in claim 19, further comprising a sensor of the voltage of the high-voltage battery, a sensor of the voltage of the high-voltage network, and a system for carrying out mapping of voltages measured by one of said voltage sensors, the control device being configured to carry out the mapping of voltages measured by said voltage sensor and to establish the corrected precharging setpoint depending on the measured voltages recorded during the mapping.

24. A motor vehicle comprising:
the powertrain as claimed in claim 19.
